(19) United States
(12) Patent Application Publication
(10) Pub. No.: US 2020/0307050 A1
(43) Pub. Date: Oct. 1, 2020

(54) EXTERIOR COMPONENT, CAMERA, INTERCHANGEABLE LENS, PRINTER, AND METHOD OF MANUFACTURING EXTERIOR COMPONENT

(71) Applicant: CANON KABUSHIKI KAISHA, Tokyo (JP)

(72) Inventors: Makoto Kojima, Atsugi-shi (JP); Kei Oikawa, Kawasaki-shi (JP); Takahiro Suzuki, Tokyo (JP); Toshiyuki Sano, Tokyo (JP); Chiaki Kaneko, Yokohama-shi (JP)

(21) Appl. No.: 16/826,023

(22) Filed: Mar. 20, 2020

(30) Foreign Application Priority Data
Mar. 29, 2019 (JP) 2019-068890
Feb. 28, 2020 (JP) 2020-033349

(51) Int. Cl. B29C 45/37

(52) U.S. Cl. CPC B29C 45/37; G03B 17/14

(57) ABSTRACT

An exterior surface of an exterior component has a sea portion and an island portion, the sea portion includes a plurality of protrusions having a common axially symmetric shape, the island portion is higher than the plurality of protrusions, and glossiness of the island portion is higher than glossiness of the sea portion.

### BACKGROUND

### Field of the Disclosure

The present disclosure relates to an exterior component comprising a molded article to a surface of which design is imparted, and particularly relates to an exterior component having a low-gloss design surface.

### Description of the Related Art

In recent years, a variation for a plastic product has been increased and high designability has been required for an exterior surface of the product. An example of high-quality design includes low-gloss design, so-called matted design, in which surface reflection is suppressed. Japanese Patent Laid-Open No. 2007-160637 is a technique by which such low-gloss design is achieved. In a resin molded article of Japanese Patent Laid-Open No. 2007-160637, a surface has unevenness imitating natural leather grain and having a depth of 60 to 100 μm, and unevenness having a size with a diameter of 35 to 250 μm for controlling glossiness is further formed thereon, so that suppression of glossiness is achieved.

In a related art, however, the unevenness for controlling glossiness has a large size and is visually recognized easily, so that designability is lowered in some cases.

### SUMMARY

This disclosure is made in view of the aforementioned issue and some embodiments provide a resin molded article having a low-gloss exterior surface while suppressing lowering of designability.

An exterior component of embodiments of the disclosure is an exterior component comprising a molded article, in which an exterior surface of the exterior component has a sea portion and an island portion, the sea portion includes a plurality of protrusions each having a predetermined shape, the island portion is higher than the plurality of protrusions, and glossiness of the island portion is higher than glossiness of the sea portion.

Moreover, a camera of embodiments of the disclosure includes the exterior component in a body.

Moreover, an interchangeable lens of embodiments of the disclosure includes the exterior component in a lens tube.

Moreover, a printer of embodiments of the disclosure includes the exterior component in a top plate or a side surface.

Moreover, a manufacturing method of an exterior component of embodiments of the disclosure is a manufacturing method of an exterior component, by which the exterior component is manufactured by using a die on a base surface of which a plurality of depressions are formed, and the manufacturing method includes injecting resin in the die in which the plurality of depressions are formed by using a ball end mill tool, a tip of which has an arc shape, so that an area in plan view from a direction normal to the base surface is 23000 μm² or less, and molding a molded article.

Further features of the present disclosure will become apparent from the following description of exemplary embodiments with reference to the attached drawings.

### BRIEF DESCRIPTION OF THE DRAWINGS

FIGS. 1A and 1B schematically illustrate a surface of an exterior component of some embodiments.

FIG. 2 schematically illustrates the surface of the exterior component of some embodiments.

FIG. 3 schematically illustrates another example of the surface of the exterior component of some embodiments.

FIGS. 4A to 4E each illustrate an example of a state of protrusions of the exterior component of some embodiments.

FIGS. 5A to 5D each illustrate another example of a state of protrusions of the exterior component of some embodiments.

FIG. 6 illustrates a process apparatus usable for manufacturing the exterior component of some embodiments.

FIGS. 7A to 7D are views for explaining a die process step for manufacturing the exterior component of some embodiments.

FIGS. 8A to 8E are views for explaining an injection molding step for manufacturing the exterior component of some embodiments.

FIG. 9 illustrates an example in which the exterior component of some embodiments is applied.

FIG. 10 illustrates an example in which the exterior component of some embodiments is applied.

FIG. 11 is an external view of a die made in Example 1.

FIG. 12 is an external view of an exterior component made in Example 1.

FIG. 13A illustrates an electron microscope image of a surface of the exterior component made in Example 1, and FIG. 13B illustrates an electron microscope image of a surface of a resin molded article molded by using a die manufactured by laser processing.

FIG. 14 illustrates an electron microscope image of the surface of the exterior component made in Example 1.

FIG. 15 includes FIGS. 15(a)-(d), each of which illustrates a state of the protrusions and a normal line histogram according to some embodiments.

FIGS. 16A and 16B illustrate a relationship between cutting process and a size of a protrusion in some embodiments.

FIG. 17 illustrates a relationship between adjacent protrusions in some embodiments.

FIG. 18 illustrates an example of processing of calculating a height of a protrusion in some embodiments.

FIG. 19 is an external view of a die made in Example 2.

FIGS. 20A and 20B are views for explaining a step of processing the die made in Example 2.

FIG. 21 illustrates an image in which a surface of an exterior component made in Example 3 is visualized by a shape measuring instrument.

FIG. 22 illustrates an image in which the surface of the exterior component made in Example 3 is visualized by a shape measuring instrument.

FIG. 23 schematically illustrates a surface of an exterior component of some embodiments.

FIGS. 24A and 24B each illustrate an example of a parting level difference of some embodiments.

FIGS. 25A and 25B schematically illustrate the surface of the exterior component and the parting level difference in some embodiments.

FIG. 26 illustrates an example of processing of arranging an island portion by avoiding a boundary of dies in some embodiments.

FIG. 27 is an external view of a die made in Example 4.

FIG. 28 is an external view of an exterior component made in Example 4.

FIG. 29 illustrates an example of processing of acquiring shape information and an arrangement condition of the island portion in some embodiments.

FIG. 30 is a schematic view illustrating an example of a measurement system that measures two-dimensional intensity distribution of glossiness.

FIG. 31 illustrates an example of processing of calculating a position candidate at which the island portion is to be added in some embodiments.

FIGS. 32A to 32D are views for explaining arrangement of the island portion in the exterior surface of some embodiments.

### DESCRIPTION OF THE EMBODIMENTS

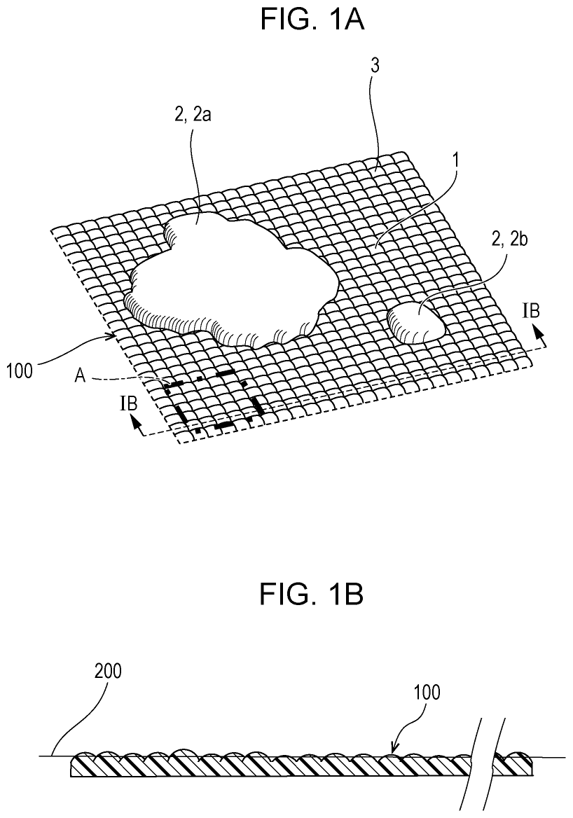

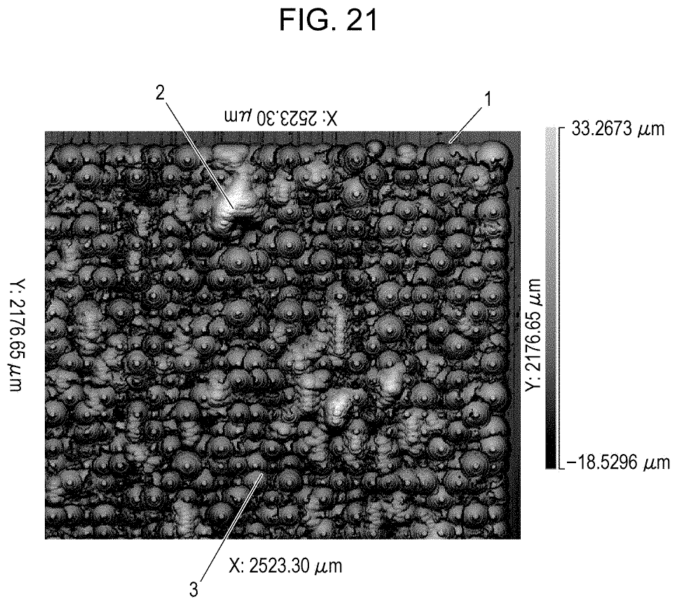

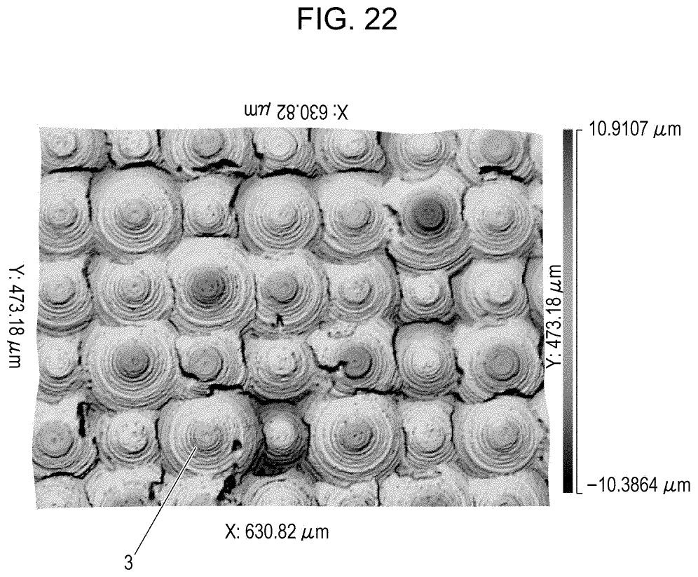

In some embodiments, a molded article having texture of leather tone coating will be described as an example of an exterior component comprising a molded article of the disclosure. FIG. 1A illustrates a state where a partial surface of the exterior component of the present embodiment is enlarged. The figure is expressed as viewed from a diagonal direction relative to a surface of the molded article. FIG. 1B is an enlarged view of a sectional surface taken along a line IB-IB in FIG. 1A. As a characteristic of a shape of the surface, first, an exterior surface 100 is constituted by a sea portion (first region) 1 having a plurality of protrusions 3 and an island portion (second region) 2. It is characterized in that glossiness of the island portion 2 is higher than glossiness of the sea portion 1. Each of the protrusions 3 may have a predetermined shape and may have an axially symmetric shape. The protrusion 3 in the present specification refers to a shape in which a depression formed by cutting process with use of an end mill is transferred to resin or a shape in which a depression formed by laser process is transferred to resin. The axially symmetric shape (or the predetermined shape) in the present specification refers to a shape in which a depression formed by cutting process with use of an end mill is transferred to resin. The axially symmetric shape refers to a shape represented by a shape as illustrated in FIG. 21, for example, when height data obtained by measuring the plurality of protrusions 3 of the sea portion 1 of the exterior surface 100 of the exterior component with use of a shape measuring instrument of a white interference type is visualized. Alternatively, the axially symmetric shape refers to a shape represented by a shape as illustrated in FIG. 22 when height data obtained by measuring the plurality of protrusions 3 of the sea portion 1 of the exterior surface 100 of the exterior component with use of the shape measuring instrument of the white interference type is visualized.

The sea portion 1 in the present specification refers to a portion provided with at least 100 or more protrusions 3 in a range of 1 mm² and each of the protrusions 3 in plan view from a direction normal to a reference plane of the exterior surface has a size falling in a circle having a diameter of 170 μm (having an area of 23000 μm² or less). The number of protrusions 3 provided in the range of 1 mm² is desirably 100. The protrusion 3 does not need to be circular in plan view and may have a crescent shape formed by overlapping circles.

The island portion 2 in the present specification refers to a portion that has an area larger than 23000 μm² and protrudes more than the protrusions 3 of the sea portion 1. An area of the island protrusion in plan view from the direction normal to the reference plane of the exterior surface may not be fixed and it is only required that an island portion having an area larger than 23000 μm² is provided, and an island portion having an area of 40000 μm² or more may be desirably provided. A protruding amount of the island portion 2 more than the protrusions 3 of the sea portion 1 is desirably 1 μm to 100 μm from the reference plane of the exterior surface 100 described later, and more desirably 1 μm to 50 μm from the reference plane of the exterior surface 100.

Each of the protrusions 3 may have, for example, a spherical surface or may have the axially symmetric shape other than the spherical surface. However, it is desirable that the plurality of protrusions 3 do not have shapes different from each other and at least a part of them has a common predetermined shape, desirably, at least a part of them has a common axially symmetric shape. When the exterior surface 100 has the protrusions 3 having such shapes, almost equal texture is able to be obtained in all directions without anisotropy. It is desirable that one protrusion 3 in plan view from the direction normal to the reference plane of the exterior surface 100 has the size falling in the circle (area of about 23000 μm² or less) having the diameter of 170 μm. Resolution to identify an object when a person having eyesight of 1.0 observes the object at a viewing distance of 60 cm is typically about 170 μm. Thus, in a case where the protrusion 3 has an area more than the area (about 23000 μm²) of the circle having the diameter of 170 μm in plan view, each protrusion 3 is identified as a shape with naked eyes. That is, each protrusion 3 is easily identified with naked eyes when having a size exceeding the circle having the diameter of 170 μm, resulting that the exterior surface 100 may be recognized as a rough surface, so that such a size is not desirable. Accordingly, the protrusion 3 is desirably formed so as to be the circle (area of 23000 μm² or less) having the diameter of 170 μm, which is not recognized as a shape. However, the protrusion 3 does not need to be circular in plan view and may have a crescent shape formed by overlapping circles. A curvature radius of a top of the protrusion 3 is desirably 10 μm or more and 500 μm or less. An effect of scattering light is greater as the curvature radius is smaller, but when the curvature radius is smaller than 10 μm, the effect of scattering light tends to be lowered on the contrary. Moreover, when the curvature radius of the top of the protrusion 3 exceeds 500 μm, the effect of scattering light tends to be lowered, so that the curvature radius of the top of the protrusion 3 is desirably 10 μm or more and 500 μm or less. However, in a case of a protrusion in which a depression formed by cutting process with use of an end mill is transferred to resin, a curvature radius of a top thereof is desirably 50 μm or more and 500 μm or less. When the curvature radius of the top of the protrusion 3 is lower than 50 μm, a quantity of light that is able to be scattered by one protrusion 3 is too small, so that 1000 or more protrusions 3 are needed, for example, per 1 mm² in some cases in order to control glossiness. An increase in the number of protrusions 3 formed on the surface of the molded article may require a lot of time to make a die, so that the curvature radius is desirably 50 μm or more. Note that, the reference plane of the exterior surface 100 is set in such a manner that a surface of a range (range A surrounded by a one-dot chain line illustrated in FIG. 1A) of 1 mm×1 mm in a range (range with only the sea portion 1) in which no island portion 2 exists in the exterior surface 100 is measured by a laser microscope, and then, a virtual plane (average plane) obtained by averaging unevenness of the surface on the basis of a result of the measurement is defined as the reference plane (200 in FIG. 1B). Moreover, there is a case where a size of the island portion 2 is small and the number of island portions 2 is large depending on a pattern, and the range in which no island portion 2 exists and which has a size of 1 mm×1 mm may not be ensured. In such a case, a region which includes the island portion 2 and has a size of 1 mm×1 mm is measured by a laser microscope and data of a part corresponding to the island portion 2 is masked and is thereby converted into data of only the sea portion 1, and a virtual plane obtained by averaging unevenness after that is defined as the reference plane.

On the other hand, it is assumed that island portions 2 are interspersed in the exterior surface 100 and each protrude more than the protrusion 3 of the sea portion 1. A protruding amount of the island portion 2 more than the protrusion 3 of the sea portion 1 is desirably about 1 μm to 100 μm from the reference plane of the exterior surface 100. Though FIG. 1A expresses different island portions (2a and 2b) as having almost equal heights, heights of all the island portions 2 may not be necessarily equal and the heights may be different for each of the island portions 2. Though the figure expresses a height in one island portion 2 as being almost fixed, the height may not be necessarily fixed in the resin molded article of the present embodiment and may have distribution of a high portion and a low portion in the island portion 2.

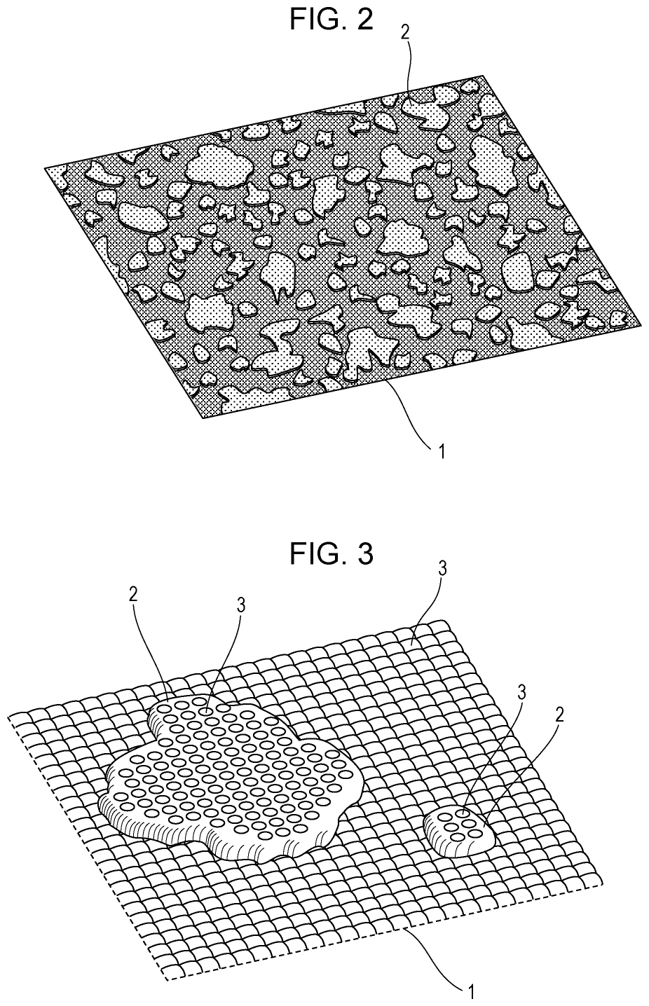

FIG. 2 illustrates a state of the exterior surface 100 of the molded article of the disclosure in a region with a wider range than that of FIGS. 1A and 1B. Moreover, FIG. 2 is expressed as viewed from a diagonal direction relative to the exterior surface 100 of the resin molded article, similarly to FIG. 1A. Moreover, FIG. 2 is expressed so that the protrusion 3 existing in the sea portion 1 of the exterior surface 100 is omitted. As illustrated in FIG. 2, it is assumed that a contour of the island portion 2 does not have a specific shape such as a circle or a polygon but has a shape formed by a plurality of concave and convex curves, and that curvatures of the curves are not fixed and the contour is formed by curves with various large and small curvatures. It is also assumed that sizes of the island portions 2 are not uniform and various large and small island portions 2 are mixed. In a case where the resin molded article of the disclosure is visually seen, the protrusion 3 existing in the sea portion 1 is assumed to have a size that is difficult to be identified. That is, by forming the protrusion 3 having the size that is difficult to be visually recognized in the sea portion 1 of the exterior surface 100, light is scattered by the protrusion 3, so that the glossiness is recognized to be low. On the other hand, in the island portion 2, the glossiness is recognized to be high. In this manner, the resin molded article of the disclosure is able to achieve texture of leather tone coating. Specifically, excellent texture of leather tone coating is able to be achieved when the glossiness of the sea portion 1 is set so that 60-degree glossiness is less than 13 gloss unit, preferably 10 gloss unit or less and the glossiness of the island portion 2 is set so that 60-degree glossiness is 13 gloss unit or more. Glossiness is able to be measured, for example, by using a 60-degree glossiness meter IQ FLEX60 manufactured by Rhopoint Instruments. Since an area each side of which is several millimeters or more is needed to measure the glossiness by the glossiness meter, the measurement is able to be performed by preparing a sample in which only a sea portion or only an island portion is formed in an area each side of which is, for example, 20 mm.

FIG. 1A illustrates an example in which only the sea portion 1 has the protrusion 3 and the island portion 2 does not have the protrusion 3. FIG. 3 illustrates an example in which not only the sea portion 1 but also the island portion 2 has the protrusion 3. In the resin molded article of the disclosure, each of the sea portion 1 and the island portion 2 may have the protrusion 3 as illustrated in FIG. 3. In this case, it is assumed that the protrusion 3 of the sea portion 1 and the protrusion 3 of the island portion 2 are different in at least one or more of density, heights, and sizes of the protrusions 3. When the sea portion 1 and the island portion 2 are the same in all the density, the heights, and the sizes of the protrusions 3, the glossiness of the sea portion 1 and the glossiness of the island portion 2 are recognized to be equal, so that an impression far from texture of leather tone coating in an appearance is given. When at least one or more of the density, the heights, and the sizes of the protrusions 3 are different, a difference is generated between glossinesses of the sea portion 1 and the island portion 2, so that excellent texture of leather tone coating is able to be achieved.

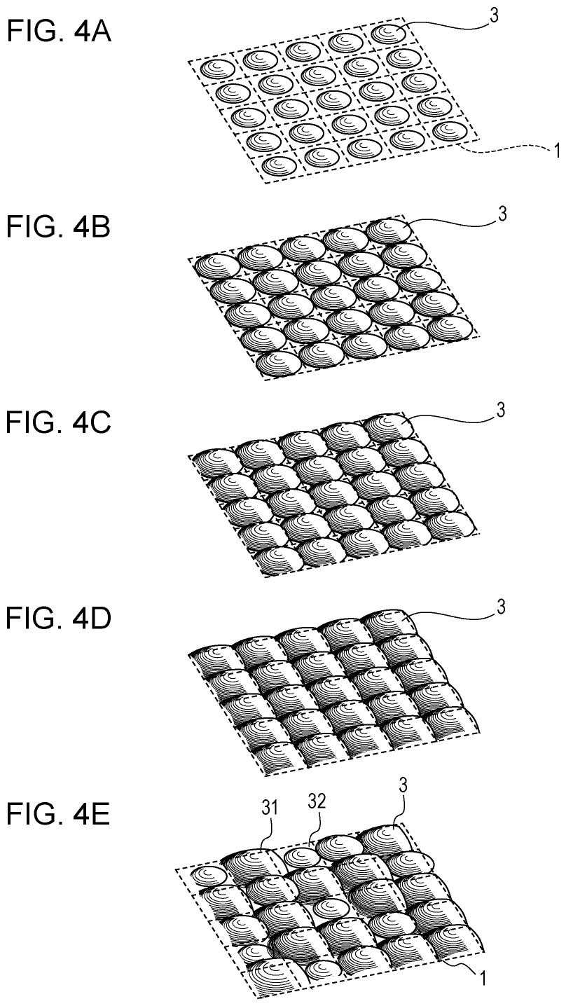

An example of a method of controlling glossiness in accordance with a state of protrusions provided on an exterior surface 1 will be described with reference to FIGS. 4A to 4E. The figures each illustrate a state where the number of protrusions per unit area is fixed and sizes of the protrusions are differentiated. In FIG. 4A, the protrusions 3 each having an axially symmetric shape are longitudinally and laterally aligned in the sea portion 1. A state where adjacent protrusions 3 are not in contact with each other is provided because the sizes are relatively small. FIG. 4B illustrates a state where the sizes of the protrusions 3 are larger than those in FIG. 4A and adjacent protrusions 3 are partially in contact with each other. FIG. 4C illustrates a state where the protrusions 3 are much larger than those in FIG. 4B and a part in which adjacent protrusions 3 are in contact with each other is increased, but a region not covered by a protrusion 3 remains in the exterior surface 1. FIG. 4D illustrates a state where the protrusions 3 have much larger sizes, a contour of one protrusion 3 is in contact with all protrusions 3 adjacent thereto and a region not covered by a protrusion 3 does not remain in the exterior surface 1. FIG. 4E illustrates a state where, next to a protrusion 31 that is high, a protrusion 32 lower than the protrusion 31 is arranged in order to further increase the size (height) of a protrusion. When FIGS. 4A to 4E are compared, a degree of scattering light by the surface is increased in order of FIGS. 4A, 4B, 4C, 4D, and 4E. Thus, the glossiness is reduced in this order. In this manner, the glossiness of the surface of the molded article is able to be controlled in accordance with the state of the protrusions.

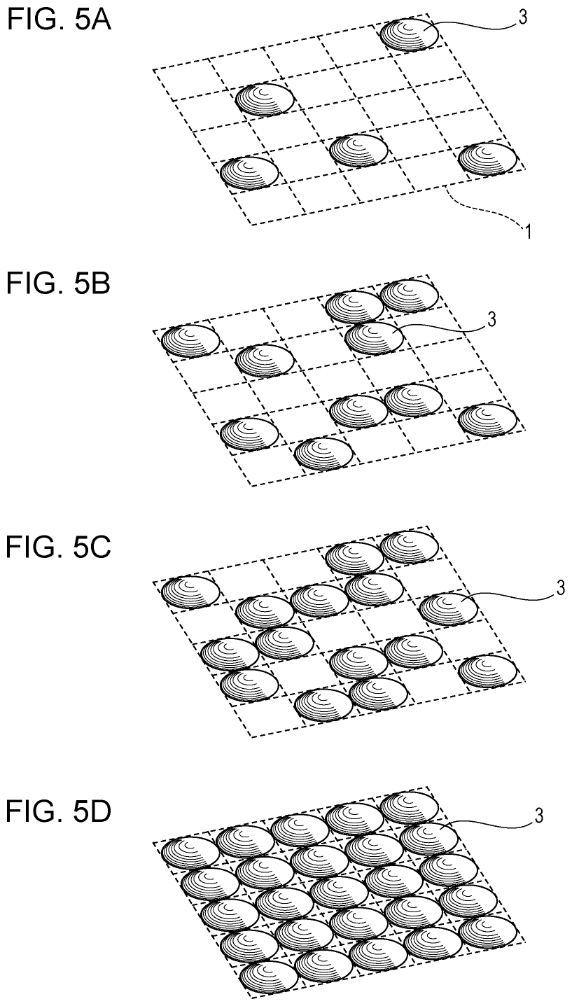

Next, another example of controlling the glossiness in accordance with the state of the protrusions 3 provided on the exterior surface 1 will be described with reference to FIGS. 5A to 5D. The figures each illustrate a state where the sizes of the protrusions 3 are fixed and the number of protrusions 3 per unit area is differentiated. In FIG. 5A, the protrusions 3 each having an axially symmetric shape are interspersed on the exterior surface 1. In FIG. 5B, the number of protrusions 3 per unit area is larger than that in FIG. 5A. In FIG. 5C, the number of protrusions 3 per unit area is much larger than that in FIG. 5B. In FIG. 5D, the number of protrusions 3 per unit area is much larger than that in FIG. 5C. When FIGS. 5A to 5D are compared, a degree of scattering light by the surface is increased in order of FIGS. 5A, 5B, 5C, and 5D. Thus, the glossiness is reduced in this order. In this manner, the glossiness of the surface of the molded article is able to be controlled in accordance with the state of the protrusions 3.

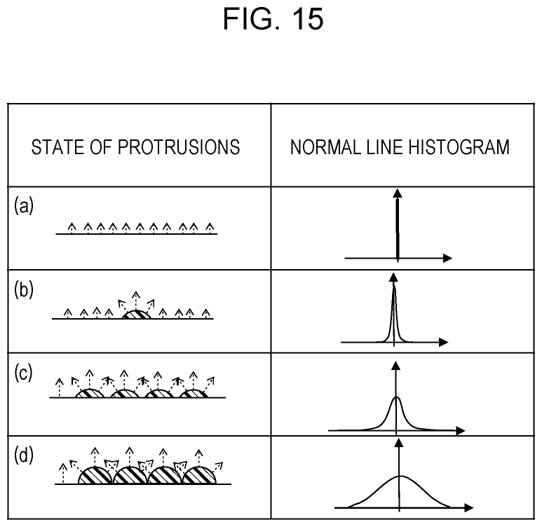

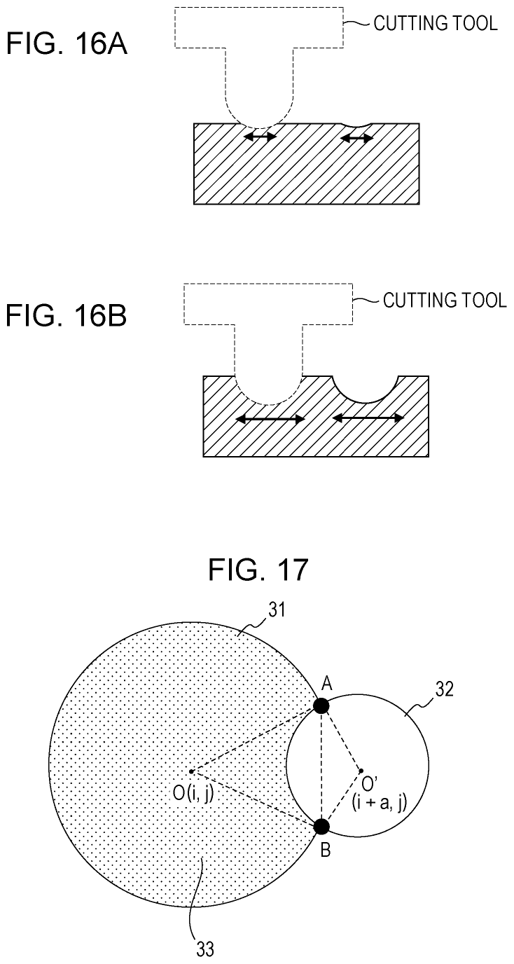

As illustrated in FIG. 15A, all normal directions in a flat plane are typically directed upward in the figure. In such a case, a normal line histogram representing distribution of normal lines has only frequency in a 0-degree direction. At this time, since all light incident on the flat plane is reflected in a specular reflection direction, a high-gloss surface is provided. On the other hand, in a case where one protrusion is arranged on the flat plane as illustrated in FIG. 15B, a surface of the protrusion has various normal lines, so that a normal line histogram representing distribution of the normal lines has dispersion greater than that of the flat plane (FIG. 15A). In such a case, since scattering is caused by an amount of light incident on the protrusion, a quantity of light reflected in the specular reflection direction is reduced as compared to that of the flat plane (FIG. 15A) and a surface with slightly low glossiness is provided. Moreover, in a case where a proportion of protrusions increases as illustrated in FIG. 15C, a proportion of the flat plane is reduced as compared to a state of FIG. 15B. In such a case, frequency of a normal line in the 0-degree direction is reduced and frequency of various normal lines of the surface of each of the protrusions increases, so that the normal line histogram has greater dispersion. In such a case, the quantity of light reflected in the specular reflection direction is further reduced as compared to that in FIG. 15B because of an increase in a proportion of the light scattered by the protrusions. Further, in a case where a depth of each of the protrusions is increased while the proportion of the protrusions is not changed as illustrated in FIG. 15D, a range of the normal direction is wider than that in FIG. 15C. In such a case, the normal line histogram has greater dispersion. At this time, a degree of scattering by the protrusions increases and the glossiness becomes lower than that in FIG. 15C. As a result, in order to make a low-gloss surface, density of the protrusions may be increased and heights of the protrusions may be increased. On the other hand, as a method of making such a protrusion, there is a method of performing cutting process for a die with use of a processor and performing resin molding with the processed die. In order to make a high protrusion by the method, a deep depression needs to be made in the die by cutting process. In a case where cutting process is used, however, when the depth is shallow as illustrated in FIG. 16A, a diameter of the depression is relatively small. On the other hand, when the depth of the depression is deep as illustrated in FIG. 16B, a size of the depression increases in accordance with a diameter of a cutting tool and the protrusion itself may be visually recognized. Thus, as indicated in a schematic view of FIG. 17 illustrating a relationship of protrusions in plan view, at least one or more small protrusions 32 adjacent to the large protrusion 31 are arranged. Thereby, a part where the protrusion 31 and the protrusion 32 are overlapped is eliminated and a structure in which an apparent area 33 in plan view has a size (about 23000 μm² or less) that is not able to be visually recognized is formed. Such a structure enables to improve dispersibility of the normal line histogram and achieve each protrusion with a size that is not able to be visually recognized. An example in which the protrusions are arrayed in a grid pattern is indicated in the explanation with reference to FIGS. 4A to 4E and FIGS. 5A to 5D, but the array of the protrusions is not limited thereto and the protrusions may be arrayed in another way, for example, in a honeycomb pattern or randomly. Further, though the examples in which the glossiness is controlled in accordance with a state of the protrusions provided on the exterior surface 1 have been described above, the glossiness is also able to be controlled similarly in accordance with a state of the protrusions provided on the island portion 2.

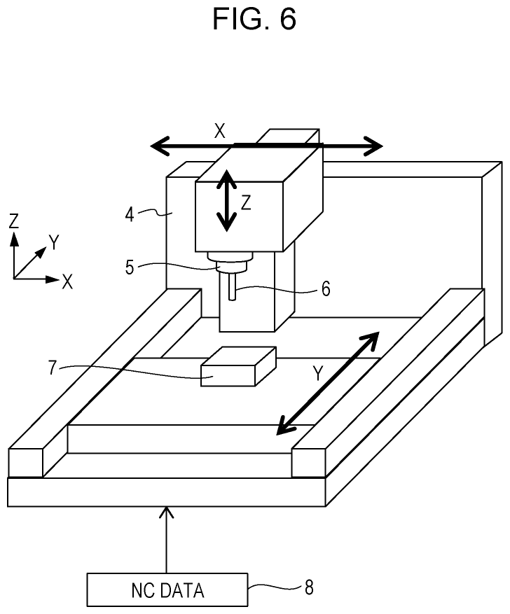

A manufacturing method of manufacturing the exterior component with the molded article of the disclosure will be described. Examples of the manufacturing method include a method of manufacturing the exterior component by transferring a depression formed by cutting process to resin and a method of manufacturing the exterior component by transferring a depression formed by laser process to resin. In some embodiments, the method of manufacturing the exterior component by transferring a depression formed by cutting process to resin will be described. FIG. 6 illustrates an example of a configuration of a machining center 4 as an apparatus that processes a die. In the example, the machining center 4 is constituted by three axes of a straight axis X, a straight axis Y, and a straight axis Z. There is also a machining center constituted by much more axes and such a machining center may be used. A main shaft 5 is used to perform cutting process by rotating an installed tool. A cutting tool is denoted by 6. A die that is a workpiece is denoted by 7. In NC data 8, commands used for cutting process, such as an amount of movement of the X axis, an amount of movement of the Y axis, and an amount of movement of the Z axis, the number of times of rotation of the main shaft 5, a feed speed of the X axis, a feed speed of the Y axis, and a movement speed of the Z axis, are described. The main shaft 5 moves and rotates relatively to the die 7 with the number of times of rotation, and the feed speeds and feed amounts of the respective axes that are described in the NC data 8. In this manner, any three-dimensional shape is able to be processed in the die 7 by the cutting tool 6 installed in the main shaft 5.

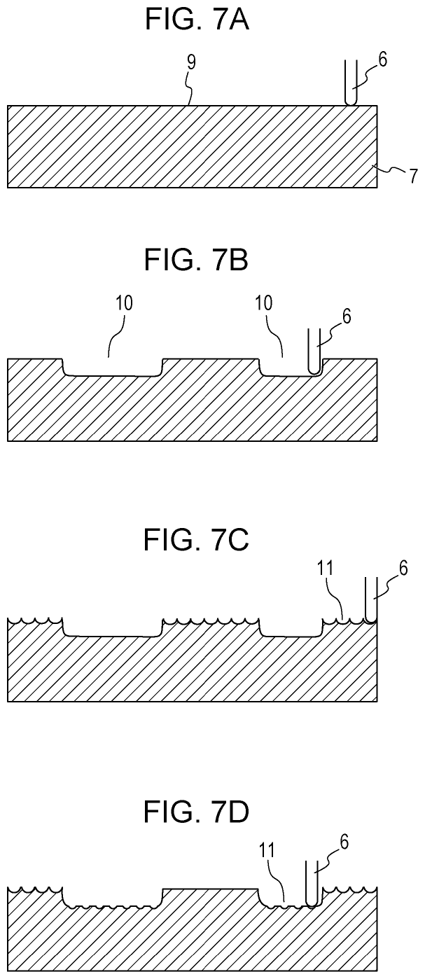

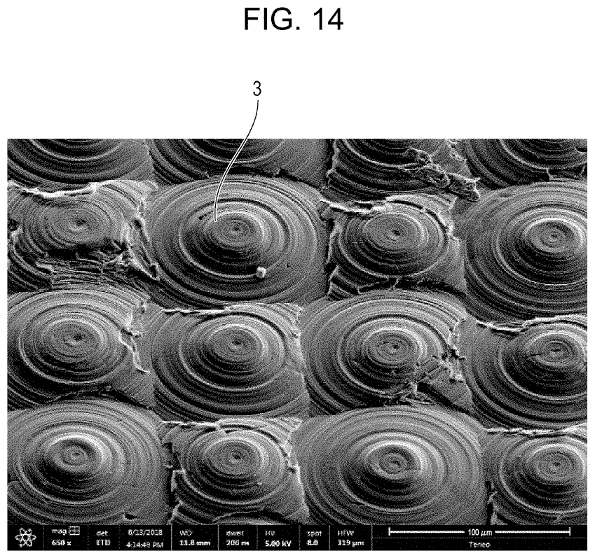

FIGS. 7A to 7D are enlarged views each illustrating a state of process performed for a surface of the die 7 with the machining center 4. The figures illustrate the surface of the die 7 as viewed from a sectional direction. First, in FIG. 7A, a surface 9 which results in a base of the die 7 is processed by the cutting tool 6. Here, as the cutting tool 6, for example, a ball end mill tool or the like is able to be selected. The die base surface (base surface) 9 can have various shapes such as a flat surface or a complicated curved surface correspondingly to a shape of a resin molded article to be molded. Thus, the base surface 9 as viewed from the sectional direction is not limited to be linear, but FIGS. 7A to 7D illustrate a case where the base surface 9 is linear as an example. Next, in FIG. 7B, concave portions 10 resulting in portions corresponding to island portions 2 are processed and interspersed in the base surface 9. Subsequently, in FIG. 7C, a plurality of depressions 11 are repeatedly processed in a portion of the base surface 9. The depressions 11 are transferred to resin as protrusions in a molded article. Moreover, in a case where the process is performed by using the ball end mill tool as the cutting tool 6, a protrusion on a surface of the molded article is able to have a substantially spherical surface, but concentric swell may be generated in the surface (refer to 3 in FIG. 14). When the plurality of depressions 11 are processed by a single tool, protrusions on the surface of the molded article are able to be processed so as to include a common axially symmetrical shape.

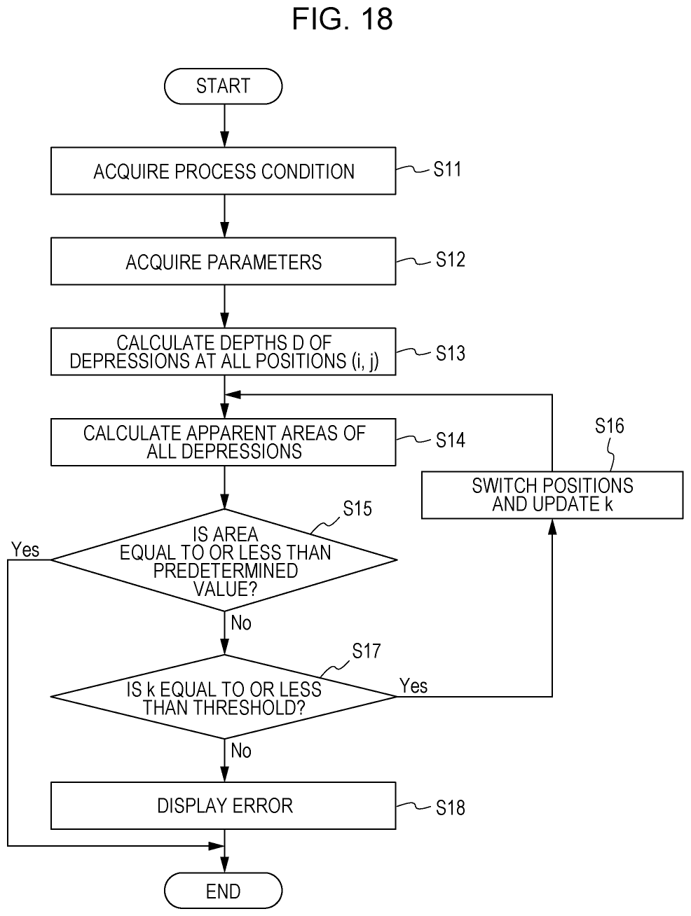

Depths of the depressions 11 may be different depending on positions. However, an area of each of the depressions 11 in plan view from a direction normal to the base surface 9 is desirably about 23000 μm² or less. An example of processing of calculating the depths of the depressions 11 at the respective positions will be described with reference to FIG. 18.

At step S11 of FIG. 18, information of a process condition is acquired. An example of the process condition includes information about a diameter R of the cutting tool 6 and an interval a of depressions 11.

At step S12, values of an average depth Z of depressions 11 to be processed and a standard deviation σ of a depth are acquired as parameters. Further, an initial value of a value of a variable k indicating replacement of positions described later and a value of Th indicting a threshold of k are acquired. Note that, as described above, glossiness is reduced as a height of a protrusion is high. Moreover, as the standard deviation is large, various depressions are able to be formed, thus making it possible to increase dispersion of normal line distribution. Note that, a relationship between the values and the glossiness is experimentally acquired in advance and appropriate values are used.

At step S13, depths D (i, j) of depressions 11 are calculated by a formula 1 at all positions (i, j) to be processed. Note that, in the formula 1, U1 and U2 are random numbers according to standard uniform distribution. In the present example, though the depths of the depressions 11 are calculated on the basis of a known Box-Muller method, the calculation of the depths of the depressions 11 is not limited thereto. For example, the calculation may be performed on the basis of a known central limit theorem.

D(1ₓ1)=a\sqrt{−2 log U₁}S1a2U₂+z (formula 1)

At step S14, in accordance with each relationship between a depth D of a depression 11, which is calculated at step S13, and a depth D of a depression 11 adjacent to the depression, apparent areas of all the depressions 11 in plan view are calculated. Here, for simplification of description, an example in which an apparent area is calculated from D (i, j) and D (i+a, j) is indicated below. Specifically, first, by solving simultaneous equations from a circle O which has a radius r1 and corresponds to the depth D (i, j) and a circle O′ which has a radius r2 and corresponds to the depth D (i+a, j), two intersections A and B are calculated. Subsequently, a difference between an area of a fan shape OAB and an area of a triangle OAB in FIG. 17 and a difference between an area of a fan shape O′AB and an area of a triangle O′AB are calculated and a difference from an area of the circle O is obtained, so that an apparent area 33 is calculated. Here, a radius r is calculated from the depth D by a formula 2.

r=\sqrt{R²−(R−D)²} (formula 2)

At step S15, whether or not the apparent area 33 calculated at step S14 is able to be visually recognized by a person is determined. When all apparent areas 33 are equal to or less than a predetermined value of about 23000 μm², it is determined that the protrusions are not able to be visually recognized, and the processing ends. Otherwise, the procedure proceeds to step S17.

At step S17, whether or not the variable k indicating replacement of positions is equal to or less than the threshold set at step S12 is determined. When the variable k is equal to or less than the threshold, the procedure proceeds to step S16, and otherwise, the procedure proceeds to step S18.

When it is determined that k is equal to or less than the threshold, at step S16, depressions 11 at all positions, apparent areas of which are determined to be able to be visually recognized, are replaced with depressions 11 at any positions and the value of k indicating the variable for replacement of positions is updated and the procedure returns to step S14.

When k is larger than the threshold at step S17, at step S18, it is determined that a desired depression 11 is not able to be formed with the set parameters, an error message is displayed, and the processing ends.

On the basis of the depths of the depressions 11 obtained as described above, the plurality of depressions 11 are repeatedly processed in the portion of the base surface 9.

Next, the depressions 11 are processed in a portion corresponding to the island portion 2 in FIG. 7D. However, a step of FIG. 7D is not necessarily required to be performed in the present embodiment and is performed when the glossiness of the island portion 2 of the molded article needs to be adjusted. When the process of the depressions 11 is performed by the step of FIG. 7D, the depressions 11 to be processed at the step of FIG. 7C need to be different in at least one or more of the density, the depth, and the size. When the depressions 11 are different in at least one or more of the density, the depth, and the size, the exterior surface of the molded article and the island portion 2 are able to be differentiated in at least one or more of the density, the heights, and the sizes of the protrusions. As a result, it is possible to differentiate the glossiness between the exterior surface of the molded article and the island portion 2. Though an example in which the process is performed without changing the cutting tool 6 in all the steps of FIGS. 7A to 7D has been described in the foregoing explanation, the process is also able to be performed by changing the cutting tool 6 to a suitable tool in each of the steps.

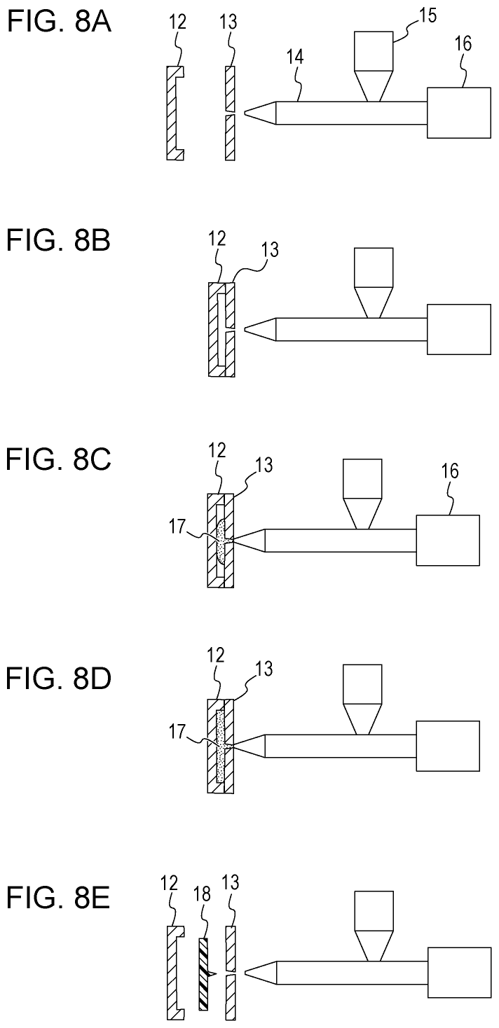

FIGS. 8A to 8E each schematically illustrate an injection molding step for manufacturing the molded article of the disclosure. As an injection molding machine, a typical injection molding machine is able to be used. FIG. 8A illustrates dies 12 and 13, a cylinder 14 which has a cylindrical shape and by which resin is injected in a die, and a portion called a hopper 15 by which a resin material is put into the cylinder 14. As the resin material, a thermoplastic material such as polyethylene, polystyrene, polypropylene, polyvinyl chloride, polyester, polyamide, or polycarbonate is able to be used. In order to obtain a resin molded article as the molded article, a resin material that is colored by mixing a colorant such as pigment in advance may be typically used. A mechanism in which a screw (not illustrated) is inside the cylinder 14 and, when the screw is rotated by a motor (not illustrated), the resin material inside the hopper 15 is fed to a tip of the cylinder 14 is provided. Moreover, the cylinder 14 includes a heater (not illustrated), and the resin material put by the hopper 15 is heated to a temperature equal to or more than a glass transition temperature of the resin material in a process of being fed to the tip through the inside of the cylinder 14 and melted to a liquid state. Then, the resultant is accumulated in a space of the tip of the cylinder 14. At a step of FIG. 8B called a die clamping step, the dies 12 and 13 are matched by a mechanism (not illustrated). The dies 12 and 13 are heated by a heater (not illustrated). A temperature at which the dies 12 and 13 are heated at the step is called a die temperature. Subsequently, at a step of FIG. 8C called an injection step, the cylinder 14 is pressed against an injection hole portion provided in the die 13. Further, a hydraulic cylinder portion 16 operates and the screw (not illustrated) is pushed in a direction of the tip of the cylinder 14, so that a melted resin material 17 is injected to a space inside the dies 12 and 13 that are matched. A temperature of the melted resin at the step is called a resin temperature. FIG. 8D illustrates steps called a keep pressure step and a cooling step. At the keep pressure step, a pressure of the hydraulic cylinder portion 16 is controlled to thereby keep a pressure of the melted resin material 17 inside the dies 12 and 13 at a desired pressure. The pressure is called a keep pressure. As the keep pressure, a pressure by which the resin material 17 spreads into every corner of the space inside the dies 12 and 13 is selected. At the cooling step subsequent to the keep pressure step, by cooling the dies 12 and 13 in FIG. 8D by a cooling mechanism (not illustrated), the resin material 17 inside the dies 12 and 13 is cooled to a temperature equal to or less than the glass transition temperature and changed from the liquid state to a solid state. The cooling mechanism adopts, for example, a method by which cooling water used for cooling is spread around the dies 12 and 13. Next, FIG. 8E illustrates steps called a die open step and a die release step. The dies 12 and 13 are opened by a mechanism (not illustrated). Subsequently, a resin molded article 18 is extracted from the dies 12 and 13 by a die release mechanism (not illustrated). At a stage where the dies 12 and 13 are opened, the resin molded article 18 is typically in a state of being stuck to a surface of the die 12 or 13. The die release mechanism performs an operation of pushing out the molded article stuck to the surface of the die 12 or 13 from the die 12 or 13 by a bar which is called an ejector pin and penetrates the die 12 or 13. Through such steps, the resin molded article 18 is able to be obtained.

In a case where the resin molded article is molded by using a plurality of dies such as the dies 12 and 13 in combination, a level difference (parting level difference) may be formed in a boundary portion where the dies are in contact. An amount of the parting level difference is not fixed and the amount of the level difference varies every molding due to many factors such as a molding condition, manufacturing accuracy of a die, and a type of resin. Thus, it is realistically difficult to eliminate the level difference by making a die in consideration of an amount of the level difference in advance. Thus, when the exterior component is molded, it is desirable that a boundary of dies is not positioned on the exterior surface from an aesthetic point of view.

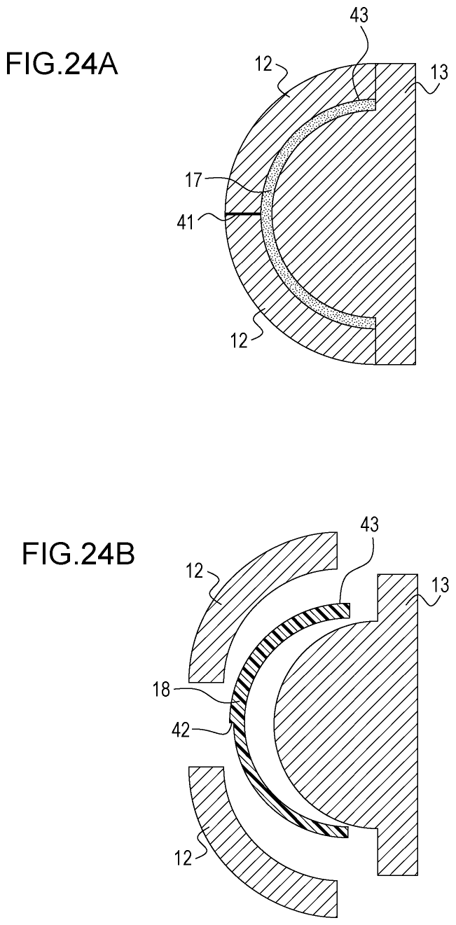

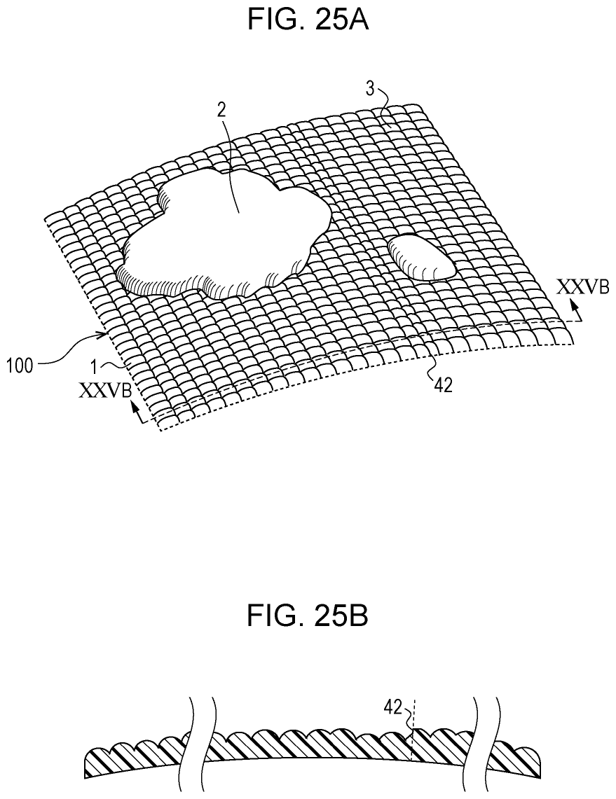

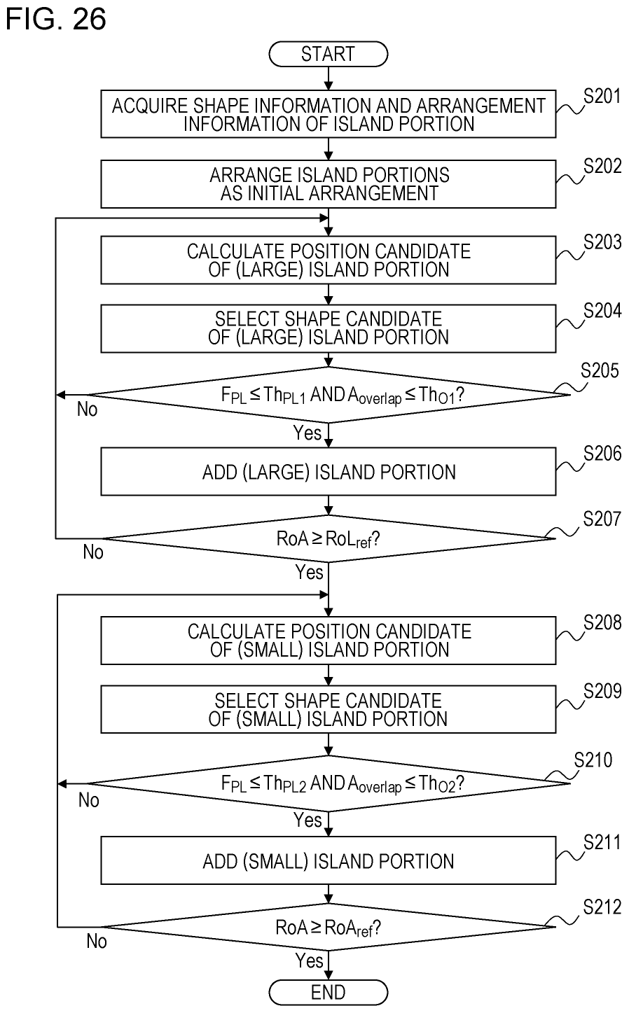

However, there is a case where the boundary of the dies needs to be arranged on the exterior surface depending on a shape of the exterior surface, for example, when the exterior surface has a curved surface. FIGS. 24A and 24B illustrate an example in which an exterior surface 43 whose sectional surface has an arc shape is formed by combining two pieces 12. In the example, a parting level difference 42 is formed at a position corresponding to a boundary 41 of the pieces 12 on the exterior surface 43 of the molded article 18. In such a case, it is desirable that a boundary line of the pieces 12 does not pass through a high-gloss island portion. Specifically, a percentage of a length of the boundary line (parting level difference) passing through the island portion in a length of the boundary line (parting level difference) in the entire exterior surface 43 is desirably equal to or less than 0.5%. That is, it is desirable that most (length exceeding 99.5%) of the boundary line passes through a sea portion. An example of a positional relationship between the parting level difference and the island portion is illustrated in FIGS. 25A and 25B. FIG. 25A illustrates a state where a part of the exterior surface of the molded article in the present embodiment is enlarged. The figure is expressed as viewed from a diagonal direction relative to the exterior surface of the molded article, similarly to FIG. 1A. FIG. 25B is an enlarged view of a sectional surface taken along a line XXVB-XXVB in FIG. 25A. The parting level difference 42 is not formed in the island portion 2 but is formed only in the sea portion 1. In the sea portion 1, reflection light by the protrusion 3 is scattered at a great degree as described above, so that an influence of scattering of the reflection light by the parting level difference 42 is less likely to be remarkable. Thus, when the island portion 2 is arranged by avoiding a boundary of dies so that the parting level difference 42 is formed in the sea portion 1, it is possible to keep appearance designability while reducing visibility of the level difference. An example of processing for achieving such arrangement of the island portion 2 will be described with reference to FIG. 26.

At S201 of FIG. 26, shape information and arrangement information of a target island portion are acquired. In the present embodiment, image data indicating a shape of an individual island portion is used as the shape information. Moreover, an area ratio of island portions and a histogram related to a distance between island portions are used as the arrangement information. As the area ratio of island portions, it is desirable that an area ratio based on a total area of all island portions is acquired and an area ratio based on a total area of only large island portions having a fixed area or more is acquired together. Moreover, the histogram related to the distance between island portions is desirably created by using a distance between large island portions. When they are used as the arrangement information, it is possible to more accurately control an arrangement balance of large island portions that are visually remarkable and to reproduce texture closer to target texture.

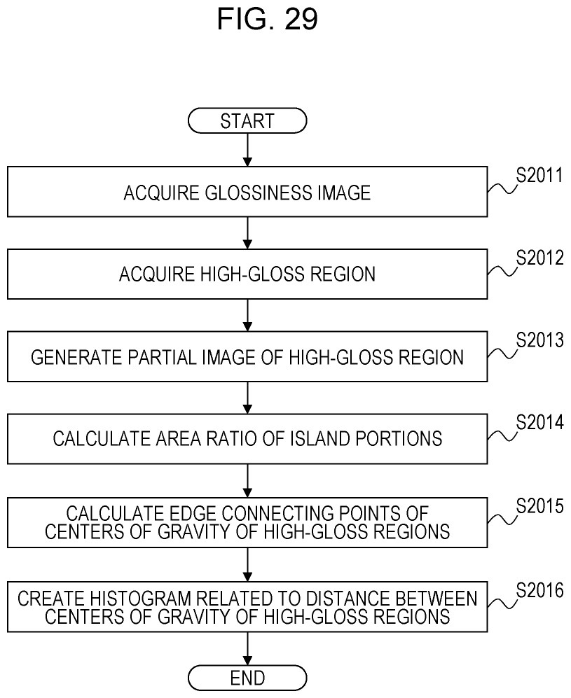

The shape information and the arrangement information of the island portion are acquired from a sample piece which has a flat plate shape and to which target leather tone coating is actually applied. A specific example of an acquiring method will be described with reference to FIG. 29.

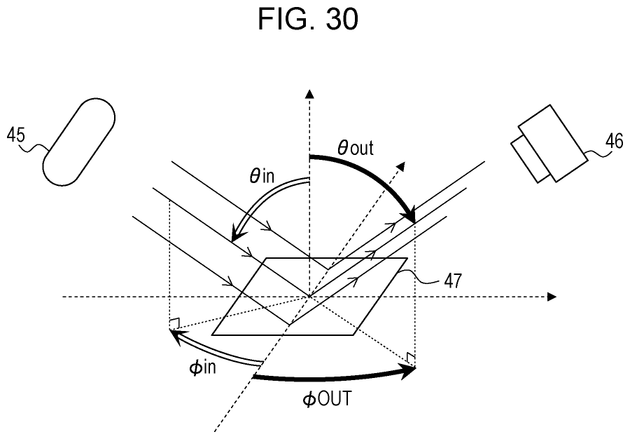

First, at step S2011, two-dimensional intensity distribution of glossiness in a leather tone coating surface (hereinafter, referred to as a coating sample) of the sample piece is acquired as a glossiness image. The two-dimensional intensity distribution of glossiness is able to be obtained by using, for example, a measurement system constituted by a light source 45 and an image capturing apparatus 46 illustrated in FIG. 30. In the figure, θin and φin indicate an incident angle of light, which is radiated from the light source 45, with respect to a measurement object 47. Moreover, φout and φout indicate a light receiving angle of the image capturing apparatus 46 with respect to the measurement object 47. By using the measurement system, light radiated from the light source 45 and reflected by the measurement object 47 is imaged multiple times by the image capturing apparatus 46 while changing the incident angle (θin, φin) and the light receiving angle (φout, φout). Then, from a group of a plurality of images thus obtained, a maximum pixel value related to the same position on the measurement object 47 is obtained as glossiness intensity, and the two-dimensional intensity distribution of glossiness is obtained. Note that, as the light source 45, for example, a combination of a white halogen lamp and a collimate optical system, or a collimated light source such as a laser light source is able to be used. Moreover, as the image capturing apparatus 46, for example, a digital camera is able to be used.

Next, at step S2012, the glossiness image obtained at step S2011 is binarized to extract a region having high glossiness intensity and known labeling processing is applied to the extracted region to acquire a plurality of high-gloss regions. In some embodiments, the high-gloss regions are regarded as island portions. A threshold used for binarizing may use a threshold defined in advance or may be calculated by applying a known method such as a discriminant analysis method to the glossiness image.

Next, at step S2013, pixels are extracted from the glossiness image, which is obtained at step S2011, for each of the high-gloss regions obtained at step S2012 to generate a partial image, and a group of partial images thus obtained is used as the shape information of the island portion. Hereinafter, the individual partial image is called shape data and an entire group of the partial images is called a shape data set.

Next, at step S2014, a total area of the high-gloss regions obtained at step S2012 is calculated and a ratio of the area relative to an entire area of the coating sample is calculated as an area ratio RoA_{ref} of the island portions. Further, a total area of regions whose area is equal to or more than a threshold Th_{L} in the high-gloss regions is calculated and a ratio of the area relative to the area of the entire coating sample is calculated as an area ratio RoL_{ref} of the large island portions.

Next, at step S2015, for the regions whose area is equal to or more than the threshold Th_{L} in the high-gloss regions obtained at step S2012, coordinates of points of centers of gravity in regions of the coating sample are calculated. Then, by obtaining two-dimensional Delaunay triangulation in which the points of centers of gravity are regarded as Delaunay points, the points of centers of gravity are connected by a Delaunay edge.

Next, at step S2016, a histogram of a length (that is, distance between centers of gravity of large island portions) of the Delaunay edge obtained at step S2015 is created. Hereinafter, the histogram obtained here is indicated by H_{ref}. A bin including a length d is indicated by n(d) and a ratio of frequency of the bin n(d) relative to total frequency of all bins of the histogram H_{ref} is indicated by H_{ref}(n(d)).

By the foregoing processing, the shape data set indicating shapes of island portions in the target coating sample, and the area ratio of the island portions and the histogram related to the distance between island portions, which are the arrangement information, are acquired. Hereinafter, description will be given with reference back to FIG. 26.

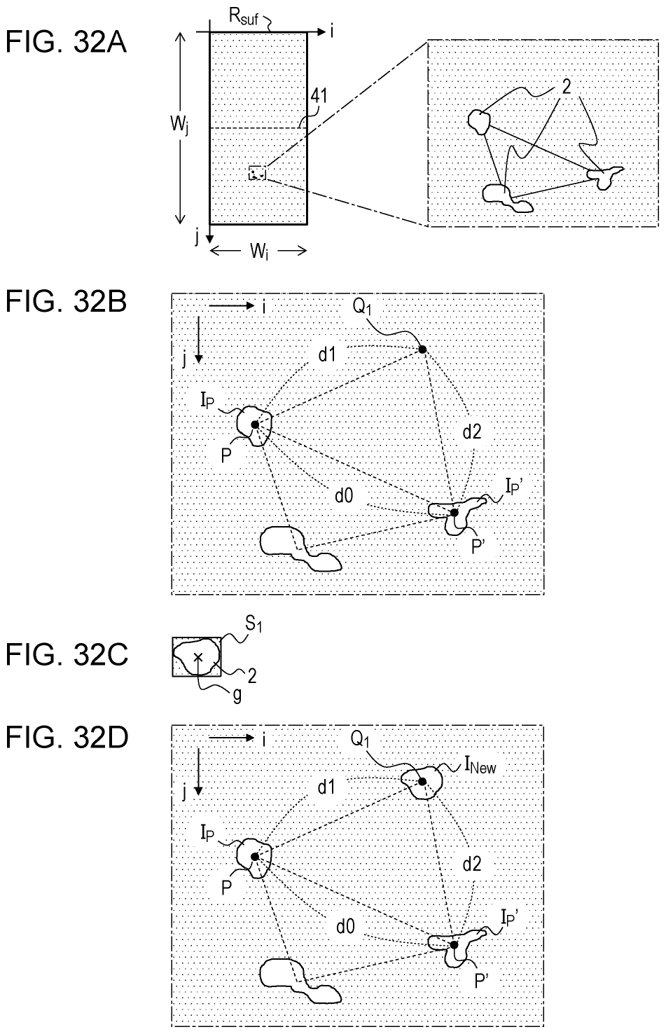

At step S202, three island portions are arranged on an exterior surface so as not to be overlapped with a boundary line of dies, as initial arrangement. An example in which the island portions are arranged in a region R_{suf} obtained by planarly developing the exterior surface will be described. FIG. 32A illustrates an example of the region R_{suf}. In the figure, the region R_{suf} is a region obtained by planarly developing the exterior surface 43 of FIGS. 24A and 24B and has a bonding portion 41 of the dies 12 crossing a center thereof. First, any one triangle is selected from Delaunay triangles obtained at step S2015. Next, three island portions connected by sides of the triangle are extracted from the coating sample. Then, while keeping a relative positional relationship between the extracted island portions, the island portions are arranged at positions where none of them is overlapped with the boundary line of the dies 12 in the region R_{suf}.

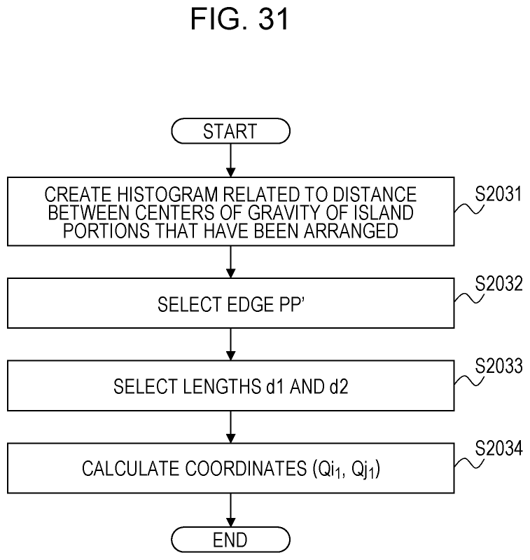

At step S203, candidate coordinates of a position at which a large island portion is to be newly added are calculated. In some embodiments, coordinates by which a histogram of a distance between island portions related to the exterior surface becomes closer to the histogram H_{ref} related to the coating sample are calculated as the candidate coordinates. Details thereof will be described below with reference to FIG. 31.

First, at step S2031, coordinates of points of centers of gravity of the island portions, which have been arranged, in the regions R_{suf} are calculated, and Delaunay triangulation is obtained and points of centers of gravity are connected by Delaunay edges similarly to step S2015. Further, a histogram of lengths of the obtained Delaunay edges is created similarly to step S2016. Hereinafter, the histogram is indicated by H.

Next, at step S2032, one edge is randomly selected from Delaunay edges which are obtained at step S2031 and relate to the island portions that have been arranged. Hereinafter, both endpoints of the edge are indicated by P and V.

Next, at step S2033, two edges are randomly selected from Delaunay edges in which frequency of a length d thereof satisfies H_{ref} (n(d))>H (n(d)) among the Delaunay edges of the coating sample that are obtained at step S2015. Hereinafter, lengths of the two selected edges are indicated by d1 and d2. At this time, both the lengths d1 and d2 are lengths frequency of each of which is insufficient in the exterior surface as compared to that of the coating sample.

Next, at step S2034, coordinates (Qi₁, Qj₁) of a vertex Q₁ of a triangle whose base is an edge PP′ selected at step S2032 and whose remaining two sides have the lengths d1 and d2 selected at step S2033 are calculated in accordance with a formula 3.

$$\{ \begin{matrix}{Qi}_{1} = Pi + d 1 * cos ( α + β ) \\ {Qj}_{1} = Pj + d 1 * sin ( α + β ) \\ α = {tan}^{- 1} ( \frac{{P}^{′} j - Pj}{{P}^{′} i - Pi} ) \\ β = {cos}^{- 1} ( \frac{d {0}^{2} + d {1}^{2} - d {2}^{2}}{2 * d 0 * d 1} )\end{matrix} \qquad ( formula 3 )$$

In the formula, (Pi, Pj) indicates coordinates of the point P, (P′i, P′j) indicates coordinates of the point P′, and d0 indicates a length of the side PP. An example of the point Q₁ in this case is illustrated in FIG. 32B. FIG. 32B is a schematic view illustrating an enlarged state of a part of the region R_{suf}, and Iₚ and I_{p′} in the figure indicate the island portions that have been already arranged. Since the lengths d1 and d2 which respectively connect the point Q₁ and the island portions Iₚ and I_{p′} that have been already arranged are lengths frequency of each of which is insufficient as described above, when a new island portion is added at a position of the point Q₁, the histogram of the distance between island portions, which relates to the exterior surface, becomes closer to the histogram H_{ref} related to the coating sample. Note that, in a case where d0, d1, and d2 do not satisfy a condition to satisfy a triangle (that is, the point Q₁ does not exist), the bottom PP′ may be selected again or the lengths d1 and d2 of the remaining sides may be selected again.

The coordinates (Qi₁, Qj₁) obtained by the foregoing processing are defined as the candidate coordinates of a position at which a large island portion is to be newly added. Hereinafter, description will be given with reference back to FIG. 26.

At step S204, one piece of shape data in which an area of the island portion is equal to or more than the threshold Th_{L} is selected from the shape data set acquired at step S2013 and the shape data is defined as a candidate of a shape of the large island portion to be newly added. Hereinafter, the shape data selected here is indicated by s₁. An example of the shape data s₁ is illustrated in FIG. 32C. In the figure, a point g is a center of gravity of the island portion 2.

At step S205, determination about overlapping of the large island portion to be newly added with a boundary line of dies and the island portion that has been arranged is performed. First, a new island I_{NEW} whose shape is indicated by the shape data s₁ selected at step S204 is temporarily placed in the region R_{suf} so that a center of gravity thereof is matched with the candidate coordinates (Qi₁, Qj₁) calculated at step S203. An example of the island portion I_{NEW} that is temporarily placed is illustrated in FIG. 32D. In FIG. 32D, the shape of the island portion I_{NEW} is the same as the shape of the island portion 2 in the shape data s₁ illustrated in FIG. 32C and has a position of the center of gravity g matched with the point Q₁ (Qi₁, Qj₁). Next, an overlapping amount F_{PL} of the island portion I_{NEW} that is temporarily placed and the boundary line between the dies and an overlapping amount Aₒᵥₑᵣₗₐₚ of the island portion I_{NEW} that is temporarily placed and the island portion that has been arranged are calculated. In some embodiments, the overlapping amount F_{PL} of the island portion I_{NEW} that is temporarily placed and the boundary line between the dies is calculated in accordance with a formula 4.

F_{PL}=L_{I}/L_{A} (formula 4)

In the formula, L_{I} indicates a length of the boundary line between the dies, which is overlapped with the island portion I_{NEW}, and L_{A} indicates an entire length of the boundary line of the dies, which is included in the exterior surface. In addition, as the overlapping amount Aₒᵥₑᵣₗₐₚ of the island portion I_{NEW} that is temporarily placed and the island portion that has been arranged, an overlapping area of the island portion I_{NEW} that is temporarily placed and the island portion that has been arranged is calculated. When the obtained overlapping amount satisfies F_{PL}<Th_{PL1} and Aₒᵥₑᵣₗₐₚ<Th_{O1}, it is determined that overlapping is not generated and the procedure proceeds to step S206 to decide addition of the island portion I_{NEW} that is temporarily placed. Otherwise, it is determined that overlapping is generated and the procedure returns to step S203. Here, Th_{PL1} and Th_{O1} respectively indicate allowable amounts of F_{PL} and Aₒᵥₑᵣₗₐₚ that are defined in advance for the large island portion.

At step S207, whether an area ratio of large island portions arranged through the foregoing processing reaches a target is determined. First, a total area of island portions currently arranged on the exterior surface is calculated and a ratio of the area relative to an entire area of the exterior surface is calculated as an area ratio RoA. When the obtained area ratio RoA is equal to or more than an area ratio RoL_{ref} of the large island portions in the coating sample, it is determined that the target is reached (that is, the large island portions are sufficiently arranged), and the procedure proceeds to step S208. Otherwise, the procedure returns to step S203.

At step S208, candidate coordinates of a position at which a small island portion is to be newly added are calculated. In some embodiments, random position coordinates (Qᵢ₂, Qⱼ₂) in the region R_{suf} are calculated in accordance with a formula 5 and defined as the candidate coordinates of the position at which the small island portion is to be newly added.

$$\{ \begin{matrix}{Qi}_{2} = U 3 * {W}_{i} \\ {Qj}_{2} = U 4 * {W}_{j}\end{matrix} \qquad ( formula 5 )$$

In the formula, U3 and U4 are random numbers according to standard uniform distribution and Wᵢ and Wⱼ are a width and a height of the region R_{suf}.

At step S209, one piece of shape data in which an area of the island portion is less than the threshold Th_{L} is selected from the shape data set acquired at step S2013 and the shape data is defined as a candidate of a shape of the small island portion to be newly added. Hereinafter, the shape data selected here is indicated by s₂.

At step S210, similarly to step S205, determination about overlapping of the small island portion to be newly added is performed. Specifically, the shape data s₁ and the candidate coordinates (Qi₁, Qj₁) at step S205 are replaced with the shape data s₂ selected at step S209 and the candidate coordinates (Qi₂, Qj₂) calculated at step S208 and the overlapping amount F_{PL} and the overlapping amount Aₒᵥₑᵣₗₐₚ are calculated. When the overlapping amounts that are obtained satisfy F_{PL}<Th_{PL2} and Aₒᵥₑᵣₗₐₚ<Th_{O2}, it is determined that overlapping is not generated, the procedure proceeds to step S211, and the island portion is added similarly to step S206. Otherwise, it is determined that overlapping is generated and the procedure returns to step S208. Here, Th_{PL2} and Th_{O2} respectively indicate allowable amounts of F_{PL} and Aₒᵥₑᵣₗₐₚ that are defined in advance for the small island portion.

At step S212, whether an area ratio of all island portions arranged through the foregoing processing reaches a target is determined. First, the area ratio RoA of island portions currently arranged on the exterior surface is calculated similarly to step S207. When the obtained area ratio RoA is equal to or more than an area ratio RoA_{ref} of the island portions in the coating sample, it is determined that the target is reached (that is, the island portions are sufficiently arranged), and the processing ends. Otherwise, the procedure returns to step S208.

Note that, the processing of calculating the candidate coordinates at step S203 is not limited to a method illustrated in FIG. 31 described above and random position coordinates may be calculated similarly to a method described in step S208.

In addition, though the processing (S203 to S207) of arranging a large island portion and the processing (S208 to S212) of arranging a small island portion are performed separately in some embodiments, island portions may be arranged without distinguishing sizes. In such a case, the processing of steps S203 to S207 may be omitted and a candidate of a shape of an island portion to be added may be selected from all pieces of shape data at step S209. Alternatively, the processing of steps S201 to S207 may be performed by setting an area threshold Th_{L}=0 and the processing of steps S208 to S212 may be omitted.

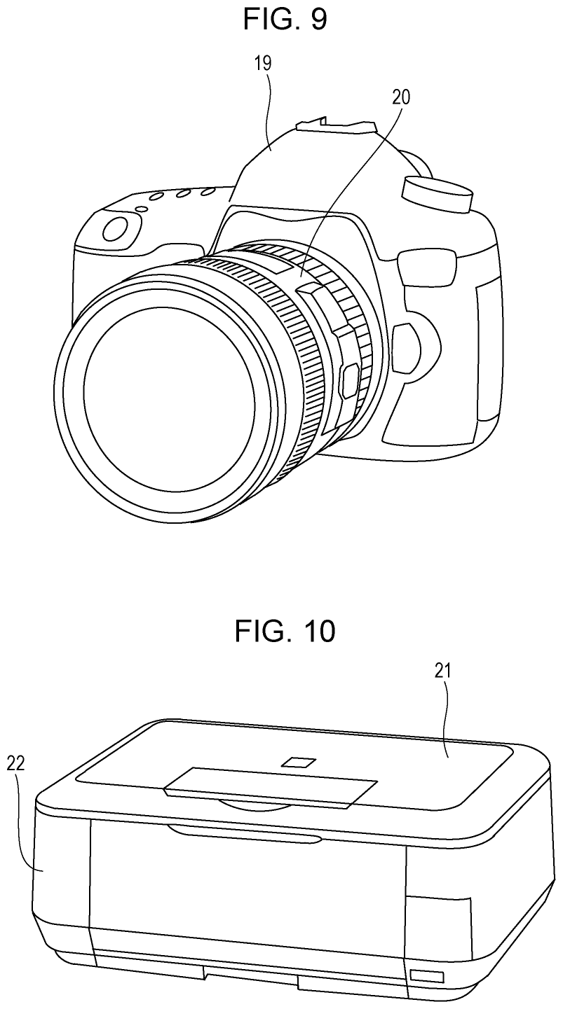

FIG. 9 illustrates an example of a molded article in which the present embodiment is able to be developed. Examples thereof include an exterior component 19 of a camera body, and an exterior component 20 of a lens tube or the like such as an interchangeable lens. FIG. 10 illustrates still another example of a molded article in which the present embodiment is able to be developed. Examples thereof include an exterior component 21 of a top plate of a printer and an exterior component 22 of a side surface thereof. The present embodiment is able to be applied not only to molded articles of the camera and the printer cited here but also to exterior components of other products. Such molded articles are typically made by using an injection molding technique, but often adopts opaque resin, which is colored by pigment or the like, as a resin material to be used. The molded articles are conventionally applied with leather tone coating to impart designability in some cases. Embodiments of the disclosure are able to be applied to all molded articles subjected to such leather tone coating.

### OTHER EMBODIMENTS

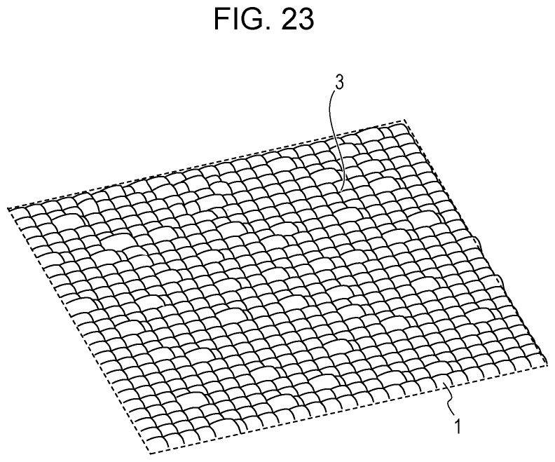

In the aforementioned embodiments, as an example of the exterior component, a molded article that has the sea portion 1 and the island portion 2 and has texture of leather tone coating has been described. However, an exterior component (refer to FIG. 23) constituted only by the sea portion 1 (without having the island portion 2) in the aforementioned embodiment is also able to provide an exterior component having texture of mat tone coating. An exterior component formed by a molded article constituted by a plurality of protrusions 3 formed in the sea portion 1 has very low glossiness and is able to freely and easily change glossiness in accordance with a height (size) of each of the protrusions 3. It is also possible to provide an excellent exterior component whose texture does not change even observed from various directions.

### EXAMPLES

Next, examples will be described.

### Example 1

In the present example, an example in which a molded article having a plate shape and texture of leather tone coating is made is indicated. First, a die as indicated by 12 in FIG. 11 is made. A surface indicated by 23 of the die 12 is processed. A three-axis control machining center 4 configured as illustrated in FIG. 6 is used to make the die 12. A state of the process of the surface 23 will be described with reference to FIGS. 7A to 7D. First, the surface 9 corresponding to the base surface is processed as illustrated in FIG. 7A. As the cutting tool 6 at this time, a ball end mill tool a tool tip of which has two blades in an arch shape and which has a tool diameter of φ0.4 mm and a corner R of 0.2 mm is used. The process is performed by performing cutting multiple times by using a cutting process condition under which a shape of the tool is sufficiently transferred to the die 12. Next, as illustrated in FIG. 7B, portions 10 corresponding to island portions interspersed in the base surface 9 are processed. As the cutting tool 6 at this time, a ball end mill tool a tool tip of which has two blades in an arch shape and which has a tool diameter of φ0.4 mm and a corner R of 0.2 mm is used. The process is performed by performing cutting multiple times by using the cutting process condition under which a shape of the tool is sufficiently transferred to the die 12. Subsequently, as illustrated in FIG. 7C, a plurality of depressions 11 are repeatedly processed in a portion of the base surface 9. As the cutting tool 6 at this time, the ball end mill tool the tool tip of which has two blades in the arch shape and which has the tool diameter of φ0.4 mm and the corner R of 0.2 mm and is the same as that in the step of FIG. 7B is used. The process is performed by performing cutting multiple times by setting an interval between depressions 11 to be fixed at 80 μm and using the cutting process condition under which the shape of the tool is sufficiently transferred to the die 12. A process depth of a depression 11 is set as 4 μm. In the present example, the step of FIG. 7D is not performed. In this manner, the die 12 of FIG. 11 is made.

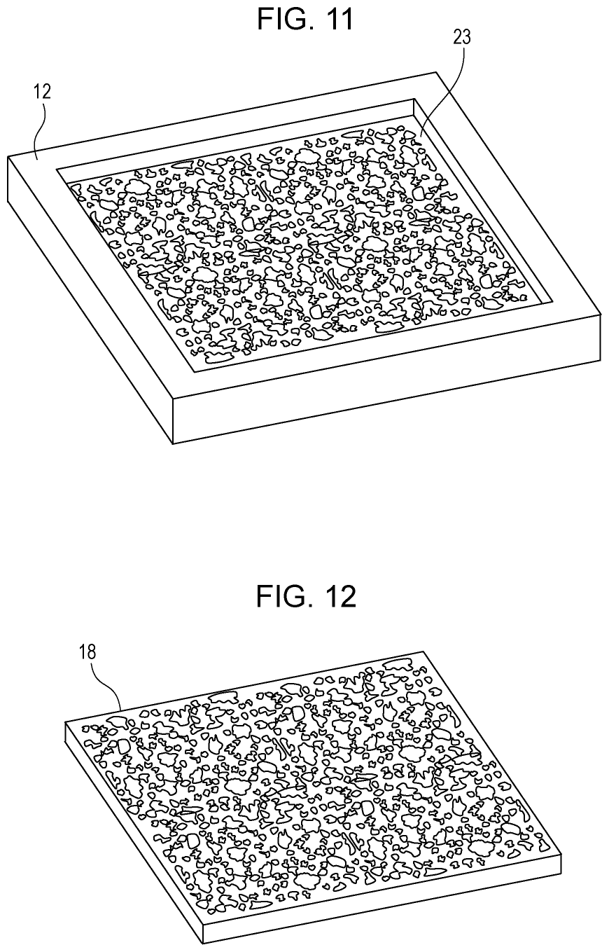

Subsequently, the injection molding step illustrated in FIGS. 8A to 8E is performed. As a molding machine, an injection molding machine J180ELIII (THE JAPAN STEEL WORKS LTD.) is used. In FIG. 8A, the die made at the previous step is used as the die 12. As resin put from the hopper 15, a polycarbonate material which contains about 30% of glass filler by TEIJIN LIMITED. and which is colored in black by a colorant is used. The molding is performed by repeating the die clamping step illustrated in FIG. 8B, the injection step illustrated in FIG. 8C, the keep pressure step and the cooling step illustrated in FIG. 8D, and the die open step and the die release step illustrated in FIG. 8E. At the injection step, by using a molding condition under which a shape of the die 12 is sufficiently transferred, the shape processed for the die 12 is transferred to the molded article 18 and the resin molded article 18 as illustrated in FIG. 12 is made.

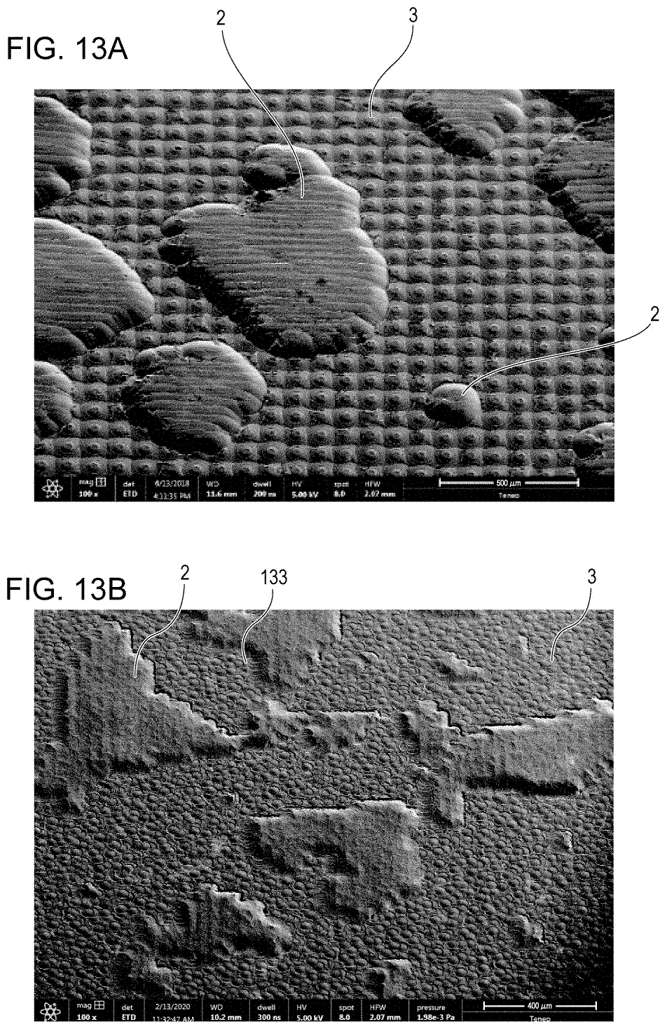

FIG. 13A illustrates a state where a surface of the resin molded article 18 made in the present example is observed by an electron microscope. A plurality of island portions 2 are formed so as to protrude more than the protrusions 3. The sea portion 1 of the exterior surface is covered by the plurality of protrusions 3. The protrusions 3 of the sea portion 1 are arrayed at an equal interval at a pitch with vertical and horizontal sizes of 80 μm. One protrusion 3 as viewed from a direction normal to the surface is a square with a size in which one side has 80 μm and a diagonal line has 113 μm. An area of one protrusion 3 in plan view from the direction normal to the reference plane of the exterior surface falls within 23000 μm² or less. Though an example in which the die is processed by using the ball end mill tool as the cutting tool has been indicated in the present example, the die is able to be manufactured also by laser processing. FIG. 13B illustrates a state where a surface of a resin molded article molded by using the die manufactured by laser processing is observed by an electron microscope. In the resin molded article molded by using the die manufactured by laser processing, a protrusion 133 of a sea portion, which has a shape (crescent shape) formed by overlapping circles, may be formed.

FIG. 14 illustrates a state where a protrusion portion of the sea portion 1 of the exterior surface in the surface of the resin molded article 18 made in the present example is further enlarged and observed by an electron microscope. Each of the protrusions 3 includes a common axially symmetric shape.

When the molded article 18 made in the present example is visually observed, each of the protrusions 3 has a size that is difficult to be identified, so that the sea portion 1 of the exterior surface appears to have a surface that is smooth and has low glossiness. On the other hand, the island portions 2 protrude more than the protrusions 3 and are able to be determined as having a state where glossiness is higher than that of the sea portion 1. An appearance of the molded article 18 is not subjected to coating at all, but has texture quite similar to that of a coating surface subjected to leather tone coating. The texture does not change even observed from various directions.

### Example 2

In the present example, an example in which a resin molded article having a plate shape and texture of mat tone coating is made is indicated.

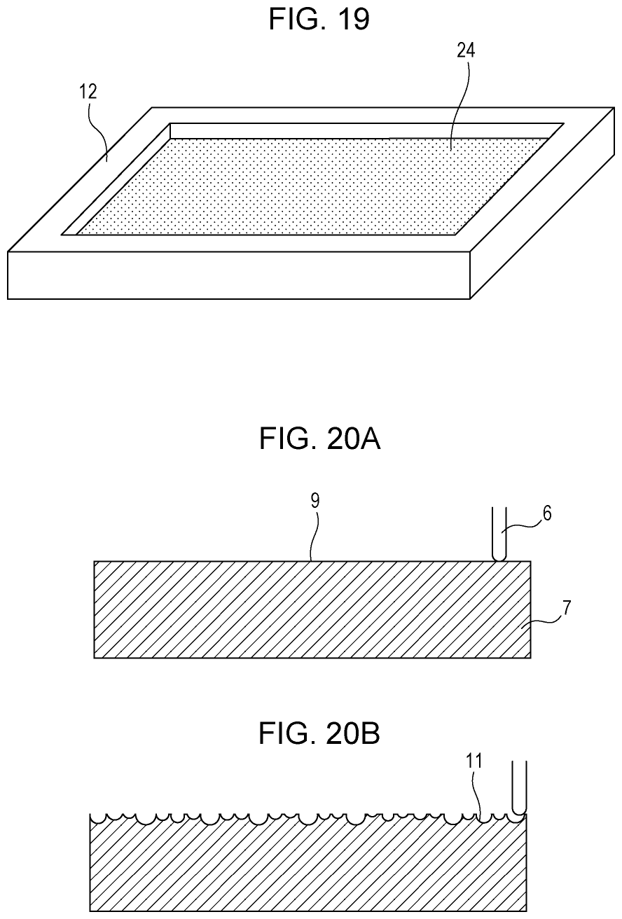

First, a die as indicated by 12 in FIG. 19 is made. A surface indicated by 24 of the die 12 is processed to achieve mat tone. A three-axis control machining center 4 configured as illustrated in FIG. 6 is used to make the die 12. A state of the process of the surface 24 will be described with reference to FIGS. 20A and 20B. First, the base surface 9 is processed as illustrated in FIG. 20A. As the cutting tool 6 at this time, a ball end mill tool a tool tip of which has two blades in an arch shape and which has a tool diameter of φ0.4 mm and a corner R of 0.2 mm is used. The process is performed by performing cutting multiple times by using the cutting process condition under which a shape of the tool is sufficiently transferred to the die 12. Subsequently, in FIG. 20B, a plurality of depressions 11 are repeatedly processed in the base surface 9. As the cutting tool 6 at this time, a ball end mill tool a tool tip of which has two blades in an arch shape and which has a tool diameter of φ0.4 mm and a corner R of 0.2 mm is used. The process is performed by performing cutting multiple times by setting an interval between the depressions 11 to be fixed at 80 μm and using the cutting process condition under which a shape of the tool is sufficiently transferred to the die 12. As the parameters of step S12 described in FIG. 18, an average depth of the depressions 11 is set as 8.0 μm and a standard deviation of a depression 11 is set as 3.0 μm. Moreover, k=0 is set as the initial value of k and Th=100 is acquired as Th. Subsequently, the injection molding step illustrated in FIGS. 8A to 8E is performed. As a molding machine, an injection molding machine J180ELIII (THE JAPAN STEEL WORKS LTD.) is used. In FIG. 8A, the die made at the previous step is used as the die 12. As resin put from the hopper 15, a polycarbonate material which contains about 30% of glass filler by TEIJIN LIMITED. and which is colored in black by a colorant is used. The molding is performed by repeating the die clamping step illustrated in FIG. 8B, the injection step illustrated in FIG. 8C, the keep pressure step and the cooling step illustrated in FIG. 8D, and the die open step and the die release step illustrated in FIG. 8E. At the injection step, by using a molding condition under which a shape of the die 12 is sufficiently transferred, the shape processed for the die 12 is transferred to the molded article 18 and the resin molded article 18 is made. When the resin molded article 18 made in the present example is visually observed, each of the protrusions 3 is not able to be identified and the exterior surface appears to have a surface that is smooth and has low glossiness. The texture does not change even observed from various directions.

### Example 3

In the present example, an example in which a resin molded article having a plate shape and texture of leather tone coating is made is indicated. First, a die is made. A three-axis control machining center 4 configured as illustrated in FIG. 6 is used to make the die. A state of the process will be described with reference to FIGS. 7A to 7D. First, the base surface 9 is processed as illustrated in FIG. 7A. As the cutting tool 6 at this time, a ball end mill tool a tool tip of which has two blades in an arch shape and which has a tool diameter of φ0.4 mm and a corner R of 0.2 mm is used. The process is performed by performing cutting multiple times by using the cutting process condition under which a shape of the tool is sufficiently transferred to the die. Next, as illustrated in FIG. 7B, portions 10 corresponding to island portions interspersed in the base surface 9 are processed. As the cutting tool 6 at this time, a ball end mill tool a tool tip of which has two blades in an arch shape and which has a tool diameter of φ0.4 mm and a corner R of 0.2 mm is used. The process is performed by performing cutting multiple times by using the cutting process condition under which a shape of the tool is sufficiently transferred to the die. Subsequently, in FIG. 7C, a plurality of depressions 11 are repeatedly processed in accordance with NC data based on information about depths of the depressions 11 created in the base surface 9 by the processing described in FIG. 18. Note that, an average depth of the depressions 11 is set as 8 μm and a standard deviation of a depression 11 is set as 3 μm. As the cutting tool 6 at this time, the ball end mill tool the tool tip of which has two blades in the arch shape and which has the tool diameter of φ0.4 mm and a corner R of 0.2 mm and is the same as that in the step of FIG. 7B is used. The process is performed by performing cutting multiple times by setting an interval between the depressions 11 to be fixed at 80 μm and using the cutting process condition under which the shape of the tool is sufficiently transferred to the die. In the present example, the step of FIG. 7D is not performed. In this manner, the die is made.

Subsequently, the injection molding step illustrated in FIGS. 8A to 8E is performed. The injection molding step is similar to that of Example 1, so that description thereof will be omitted.

FIG. 21 illustrates a state where height data obtained when the surface of the resin molded article made in the present example is measured with use of a shape measuring instrument of a white interference type is visualized. A plurality of island portions 2 are formed so as to protrude more than the protrusions 3. The sea portion 1 of the exterior surface is covered by the plurality of protrusions 3. The protrusions 3 of the sea portion 1 have a plurality of heights and an average height thereof is 8.2 μm and a standard deviation thereof is 2.7 μm. In addition, an apparent area of a protrusion 3 is about 23000 μm² or less.

FIG. 22 illustrates a state where height data obtained when the protrusions 3 of the sea portion 1 in the surface of the resin molded article made in the present example is measured with use of a shape measuring instrument of a white interference type is visualized. The respective protrusions 3 have different heights and widths but include a common axially symmetric shape.

When the resin molded article made in the present example is visually observed, each of the protrusions 3 is not able to be identified and the sea portion 1 of the exterior surface appears to have a surface that is smooth and has low glossiness. In the exterior surface, a fine luminescent point is sensed and macro glossiness is lower than that in Example 1, so that texture much closer to coating is provided. On the other hand, the island portion 2 protrudes more than the protrusion 3 and is able to be determined as having a state where glossiness is higher than that of the sea portion 1.

### Example 4

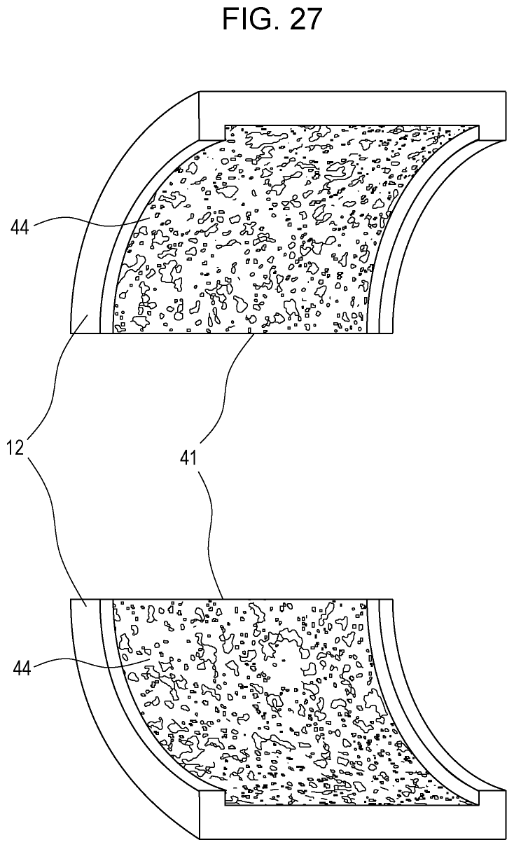

In the present example, an example in which a resin molded article having a half cylindrical shape and texture of leather tone coating is made is indicated. First, a die as indicated by 12 in FIG. 27 is made. A surface indicated by 44 of the die 12 is processed. A three-axis control machining center 4 configured as illustrated in FIG. 6 is used to make the die 12. A state of the process of the surface 44 will be described with reference to FIGS. 7A to 7D similarly to Example 1. First, the base surface 9 is processed as illustrated in FIG. 7A. As the cutting tool 6 at this time, a ball end mill tool a tool tip of which has two blades in an arch shape and which has a tool diameter of φ0.4 mm and a corner R of 0.2 mm is used. The process is performed by performing cutting multiple times by using the cutting process condition under which a shape of the tool is sufficiently transferred to the die 12. Next, as illustrated in FIG. 7B, portions 10 corresponding to island portions interspersed in the base surface 9 are processed. Shapes and positions of the island portions are decided by the processing described in FIG. 26. As parameters at this time, the threshold Th_{L} of an area, by which whether an island portion is large or small is decided, is set as 0.04 mm² and various allowable amounts used for determination about overlapping are set as Th_{PL1}=Th_{O1}=Th_{PL2}=Th_{O2}=0. Further, as the cutting tool 6, a ball end mill tool a tool tip of which has two blades in an arch shape and which has a tool diameter of φ0.4 mm and a corner R of 0.2 mm is used. The process is performed by performing cutting multiple times by using the cutting process condition under which a shape of the tool is sufficiently transferred to the die 12. Subsequently, as illustrated in FIG. 7C, a plurality of depressions 11 are repeatedly processed in a portion of the base surface 9. At this time, similarly to Example 3, the plurality of depressions 11 are processed in accordance with NC data based on information about depths of the depressions 11 created by the processing described in FIG. 18. Note that, an average depth of the depressions 11 is set as 8 μm and a standard deviation of a depression 11 is set as 3 μm. As the cutting tool 6 at this time, the ball end mill tool the tool tip of which has two blades in the arch shape and which has the tool diameter of φ0.4 mm and the corner R of 0.2 mm and is the same as that in the step of FIG. 7B is used. The process is performed by performing cutting multiple times by setting an interval between the depressions 11 to be fixed at 80 μm and using the cutting process condition under which the shape of the tool is sufficiently transferred to the die 12. The step of FIG. 7D is not performed in the present example. In this manner, the die 12 of FIG. 27 is made.

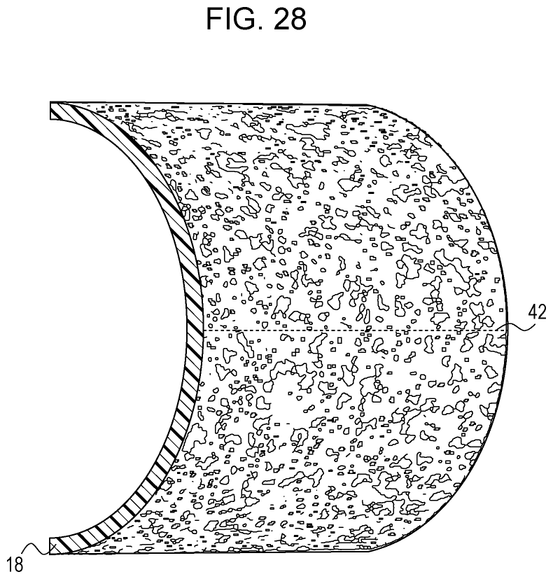

Subsequently, the injection molding step illustrated in FIGS. 8A to 8E is performed and the resin molded article 18 as illustrated in FIG. 28 is made. The injection molding step is similar to that of Example 1, so that description thereof will be omitted. The parting level difference 42 of the resin molded article 18 that is made is 15 μm.

When the resin molded article made in the present example is visually observed, the parting level difference 42 is difficult to be visually recognized and aesthetics are not spoiled by the level difference 42. Note that, the sea portion of the exterior surface appears to have a surface which is smooth and has low glossiness while a fine luminescent point is sensed, similarly to that of Embodiment 3. Moreover, the island portion protrudes more than the protrusion and is able to be determined as having a state where glossiness is higher than that of the sea portion.

While the present disclosure includes exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2019-068890, filed Mar. 29, 2019, and Japanese Patent Application No. 2020-033349, filed Feb. 28, 2020, which are hereby incorporated by reference herein in their entirety.

What claimed is:

1. An exterior component comprising a molded article, wherein
an exterior surface of the exterior component has a sea portion and an island portion,
the sea portion includes a plurality of protrusions,
the island portion is higher than the plurality of protrusions, and
glossiness of the island portion is higher than glossiness of the sea portion.

2. The exterior component according to claim 1, wherein
a surface of the island portion has a plurality of protrusions, and
the plurality of protrusions of the sea portion and the plurality of protrusions of the island portion are different in one or more of density, heights, and sizes of the protrusions.

3. The exterior component according to claim 1, wherein each of the protrusions includes a predetermined shape and the predetermined shape is an axially symmetric shape.

4. The exterior component according to claim 1, wherein an area of each of the plurality of protrusions of the sea portion in plan view from a direction normal to a reference plane of the exterior surface is 23000 μm² or less and the island portion the area of which in plan view is 40000 μm² or more is provided.

5. The exterior component according to claim 4, wherein
a curvature radius of a top of each of the plurality of protrusions of the sea portion is 10 μm or more and 500 μm or less.

6. The exterior component according to claim 5, wherein
the glossiness of the sea portion is 60-degree glossiness and a value of the 60-degree glossiness of the sea portion is less than 13 gloss unit, and
the glossiness of the island portion is 60-degree glossiness and a value of the 60-degree glossiness of the island portion is 13 gloss unit or more.

7. A camera comprising the exterior component according to claim 1 in a body.

8. An interchangeable lens comprising the exterior component according to claim 1 in a lens tube.

9. A printer comprising the exterior component according to claim 1 in a top plate or a side surface.

10. An exterior component comprising a molded article, wherein
an exterior surface of the exterior component has a plurality of protrusions, and
the plurality of protrusions include a common axially symmetric shape and an area of one protrusion in plan view from a direction normal to a reference plane of the exterior surface is 23000 μm² or less.

11. The exterior component according to claim 10, wherein the protrusions have two or more different heights.
